(19) United States
(12) Patent Application Publication
(10) Pub. No.: US 2012/0047808 A1
(43) Pub. Date: Mar. 1, 2012

(54) DOOR THRESHOLD SYSTEM AND METHODS

(76) Inventor: Norman Davidson, Kirksville, MO (US)

(21) Appl. No.: 12/869,528

(22) Filed: Aug. 26, 2010

(51) Int. Cl. E06B 1/70; E06B 3/36; E06B 7/16

(52) U.S. Cl. 49/381; 49/467

(57) ABSTRACT

In various embodiments, the present disclosure provides a door threshold system that includes a door threshold and a water barrier structured to be disposed along a bottom of the threshold. The water barrier is additionally structured to prevent water from penetrating a joint formed between a bottom of the threshold and a floor structure to which the threshold is mounted.

### FIELD

The present teachings relate to door thresholds, and more particularly to door thresholds structured to prevent water from penetrating between a bottom of the threshold and the surface on which the threshold is rests.

### BACKGROUND

The statements in this section merely provide background information related to the present disclosure and may not constitute prior art.

As is well known in the art of carpentry, generally all exterior door openings, or doorways, include a threshold, commonly referred to as a door threshold. Such door thresholds generally provide a transition between the exterior building structure and the flooring inside the respective door opening, and provide a means for preventing water and air from easily passing between the bottom of a door hung in the respective door opening and the respective flooring. For example, thresholds are generally structured to provide a barrier that fills a gap between the flooring and the bottom of the respective door to prevent rain water from passing though the gap onto the flooring inside the respective building.

Typically, an exterior door threshold is fabricated to substantially form an elongated triangular structure having a top surface, a heel portion, an intermediate portion and a toe portion, wherein the top surface is angled and declines in height from the heel portion to the toe portion. For example, the heel portion is typically structured to have a maximum height sufficient to substantially fill the gap between the bottom of the respective door and the top of the respective flooring, e.g., approximately 1-1½ inches, while the toe portion is structured to have a negligible minimum height, e.g., approximately ⅛-¼ inches or less. Hence, the top surface of the threshold is angled downward from the heel portion maximum height to the toe portion minimum height. Additionally, an exterior door threshold is typically installed such that the toe portion, i.e., approximately 1¼ inches of a distal or lower end portion of the threshold, overhangs an exterior edge of a subfloor and/or band board of the respective floor structure such that the toe portion is generally cantilevered beyond the exterior edge of a subfloor and/or band board.

More over, since thresholds are installed in door openings, they are disposed in high pedestrian traffic area of the respective building and subjected to substantial stresses as people often step on the respective threshold. Often such pedestrian traffic can cause the cantilevered toe portion to bend downward, thereby deforming the respective threshold. Furthermore, although known thresholds generally prevent rain water from passing though the gap between the bottom of the door and the flooring onto the flooring inside the respective building, known thresholds often allow rain water to flow under the threshold itself and penetrate the joint between the bottom of the threshold and the subfloor and/or the joint between the subfloor and the band board, thereby entering the interior of the building and possibly damaging the floor structure, i.e., damaging the subfloor and/or the floor joists and/or the band board.

### SUMMARY

In various embodiments, the present disclosure provides a door threshold system that includes a door threshold and a water barrier disposed along a bottom of the threshold. The water barrier is structured to prevent water from penetrating a joint formed between a bottom of the threshold and a floor structure to which the threshold is mounted.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is an isometric view of a door threshold system, in accordance with various embodiments of the present disclosure.

FIG. 1A is an isometric exploded view of the door threshold system shown in FIG. 1, in accordance with various embodiments of the present disclosure.

FIG. 1B is a side view of the door threshold system shown in FIG. 1 mounted to a floor structure, in accordance with various embodiments of the present disclosure.

FIG. 2 is front view of the door threshold system shown in FIG. 1 disposed within a doorway, shown in FIG. 2A, having a door disposed therein, in accordance with various embodiments of the present disclosure.

FIG. 2A illustrates a doorway in which the door threshold system shown in FIG. 1 can be disposed and a flooring structure to which the door threshold system shown in FIG. 1 can be mounted, in accordance with various embodiments of the present disclosure.

FIG. 3 is an illustration of a pre-hung door system including the door threshold system shown in FIG. 1, in accordance with various embodiments of the present disclosure.

FIG. 4 is a cross-sectional view of an I′ shaped water barrier of the door threshold system shown in FIG. 1, in accordance with various embodiments of the present disclosure.

FIG. 4A is a cross-sectional view of a triangular shaped water barrier of the door threshold system shown in FIG. 1, in accordance with various embodiments of the present disclosure.

FIG. 4B is a cross-sectional view of a square shaped water barrier of the door threshold system shown in FIG. 1, in accordance with various embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements.

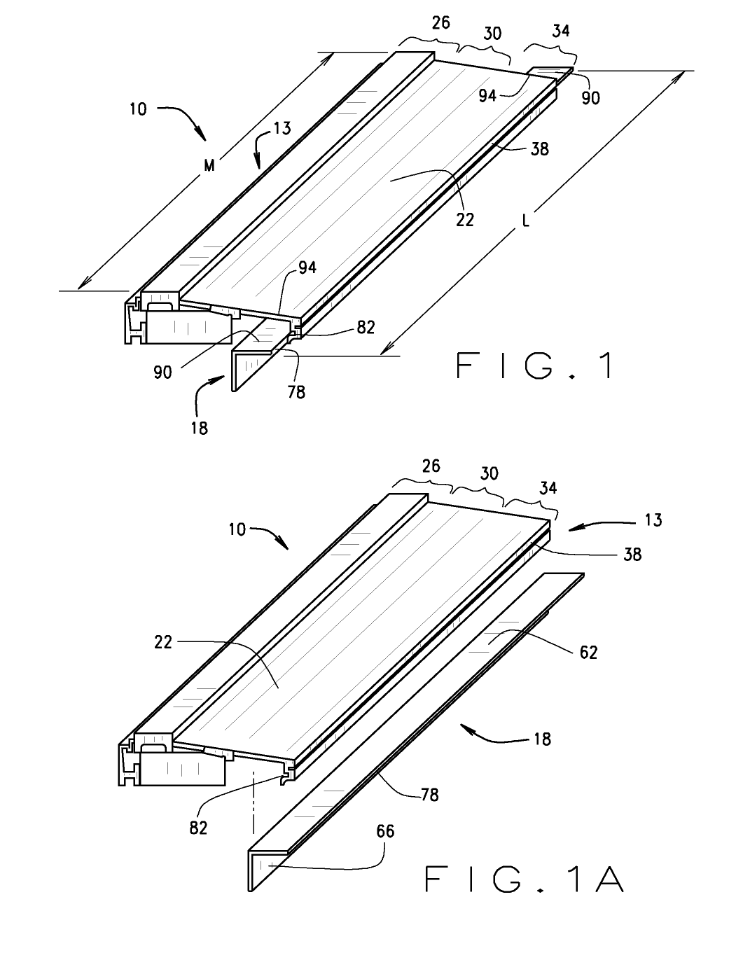

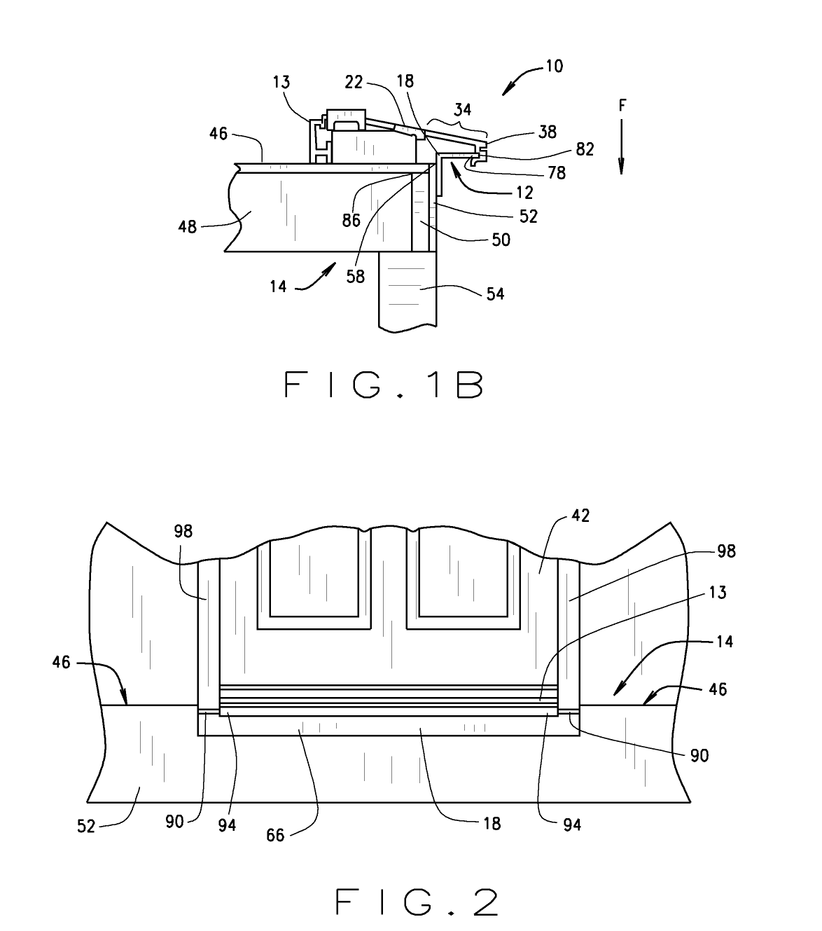

Referring to FIGS. 1, 1A and 1B, in various embodiments, the present disclosure provides a door threshold system 10 that is structured and operable be disposed at the base of a doorway 11 (shown in FIG. 2A) and to prevent water and other fluids from penetrating a joint, or gap, 12 formed between a bottom of a threshold 13 of the door threshold system 10 and a floor structure 14 to which a threshold system 10 is mountable. The door threshold system 10 generally includes the threshold 13 and a water barrier 18 that is disposable along a bottom side of the threshold 13.

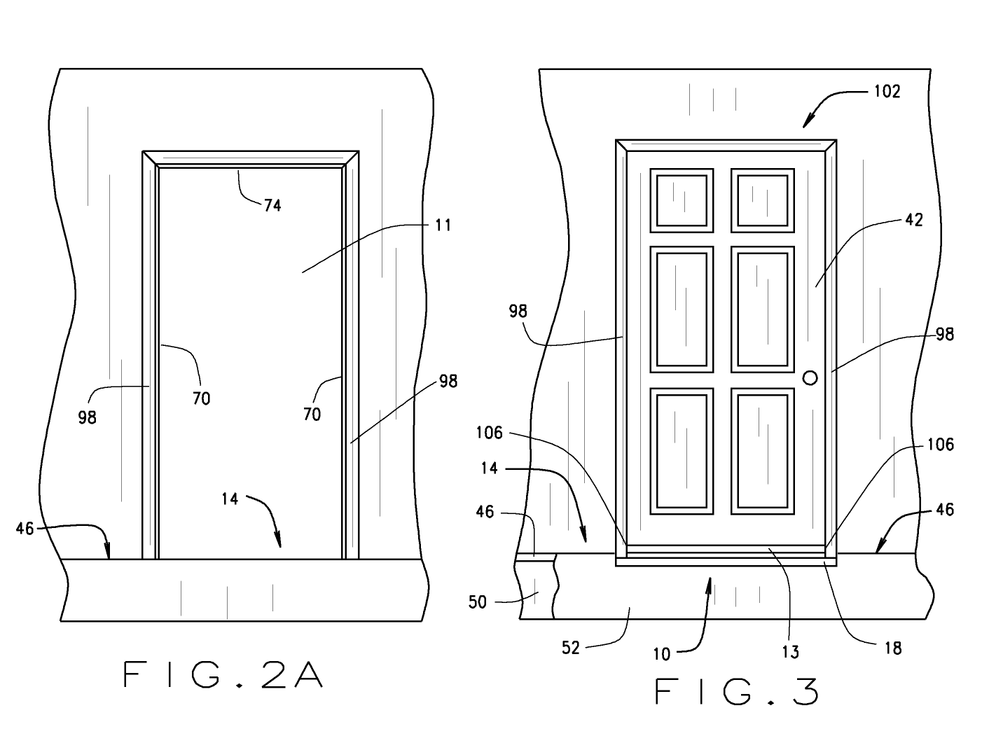

The threshold 13 is generally fabricated to form an elongated triangular structure having a top surface 22, a heel portion 26, an intermediate portion 30 and a toe portion 34, wherein the top surface 22 is angled and declines in height from the heel portion 26 to a nose 38 of the toe portion 34. In various implementations, the heel portion 26 can be structured to have a maximum height sufficient to substantially fill a gap between the bottom of a respective door 42 (shown in FIGS. 2 and 3) disposed within the doorway 11 and the top of a flooring 46 of the floor structure 14, e.g., approximately 1-1½ inches. The toe portion 34 is structured to have a negligible minimum height, e.g., approximately ⅛-¼ inches or less. Hence, the top surface 22 of the threshold 13 is angled downward from the heel portion 26 maximum height to the toe portion 34 minimum height.

The floor structure 14 generally includes a plurality of floor joists 48 (only a single joist 48 is shown), the flooring 46 disposed on a top edge of the floor joists 48, a band board 50 attached to a distal end of each respective floor joist 48 and a layer of boxing 52 attached to an exterior side of the band board 50. Additionally, a distal end portion of each respective floor joist 48 rests upon a foundation wall 50. It should be understood that, as used herein, the flooring 46 includes a subflooring material, e.g., plywood, and a flooring finish material, e.g., hardwood, vinyl or tile, disposed on top of the subflooring, as is readily known in the art.

The water barrier 18 comprises an elongated structure that is structured to be disposed along the bottom of the toe portion 34 of the threshold 13 such that the water barrier 18 covers the joint 12 formed between the bottom of the threshold 13 and the floor structure 14, thereby preventing water, and other liquids, from penetrating the joint 12. In various embodiments, the water barrier 18 can be integrally formed with the threshold 13, that is, the threshold is fabricated, or constructed, to include the water barrier 18 disposed along the bottom side of the toe portion 34 of the threshold 13. Alternatively, in other various embodiments, the water barrier 18 can be separated from and connectable to the threshold 13, via fasteners such as screws, rivet, glue or nuts and bolts, along the bottom side of the toe portion 34 of the threshold 13.

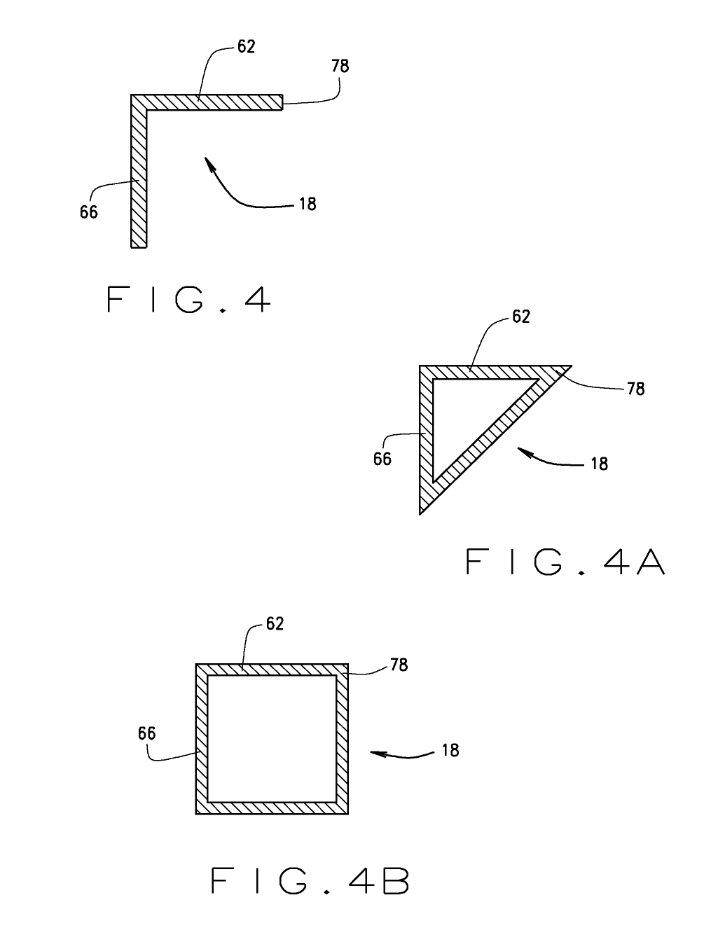

Referring now to FIGS. 1, 1A, 1B, 4, 4A and 4B, furthermore, the water barrier 18 can be any elongated metal, or other material, structure suitably structured to be disposed along the bottom of toe portion 34 of the threshold 13 and be mounted, or connected, to the band board 50 such that the joint 12 is covered sufficiently to prevent water, and other liquids, from penetrating the joint 12. For example, as exemplarily illustrated in FIGS. 4, 4A and 4B, the water barrier 18 can be an elongated structure having an I′ shaped cross-section, a triangular cross-section or a square cross-section. Generally, the water barrier 18 includes a first leg 62 that extends the length of the water barrier 18 and is structured to be connected to the threshold toe portion 34 and a second leg 66 that extends from the first leg 62 at approximately a 90° angle and extends the length of the water barrier 18.

Referring now to FIGS. 1B, 2 and 2A, as described above, the door threshold system 10 is mountable to the floor structure 14. More particularly, the threshold 13 is structured and operable to be mounted on top of the floor structure 14, i.e., on top of the flooring finish material, and the water barrier is structured and operable to be connected to, or integrally formed with, the bottom of the threshold 13, and to be mounted to the exterior side of the band board 50 having the boxing 52 disposed there between. The threshold 13 can be mounted to the top of the floor structure 14 using any suitable fasteners, e.g., screws or anchors, that extend through the flooring finish material and into the subflooring and/or the floor joists 48 and/or the band board 50. Similarly, the water barrier can be mounted to the band board 50 using any suitable fasteners, e.g., screws or anchors, that extend through the boxing 52 and into the band board 50. In various implementations, the flooring structure 14 can be absent the boxing 52 covering the exterior side of the band board 50. In such embodiments, the water barrier 18 can be disposed on an exterior side of the band board 50 and mounted directly to the band board 50 via fasteners, e.g., screws or anchors.

Referring particularly to FIG. 1B, when properly positioned and mounted to the floor structure 14, the threshold 13 is installed such that the toe portion 34, i.e., approximately 1¼ inches of a distal or lower end portion of the threshold 13, overhangs an exterior edge 58 of the respective floor structure 14 such that the toe portion 34 is generally cantilevered beyond the exterior edge 58. A shown in FIG. 1B, the cantilevering of the toe portion 34 defines the joint, or gap, 12 between the bottom of the threshold 13 and the floor structure 14.

Referring now to FIGS. 1, 1A, 1B, 2 and 2B, an exemplary process for installing the door threshold system 10 into a doorway 11, wherein the doorway 11 has been prepared to include a door frame having opposing door jams 70 and a connecting door header 74 such that a door 42 can be hung on a selected one of the door jams, will now be described.

In the embodiments wherein the threshold 13 and the water barrier 18 are separate, independent components, initially, the water barrier 18 is connected to the bottom of the threshold 13 using any suitable fasteners, e.g., screws, glue, rivets, nuts and bolts. In various implementations, a distal edge 78 of the water barrier first leg 62 is connected to a backside of the threshold nose 38 to prevent water, and other liquids, from passing between the water barrier first leg 62 and the bottom of the threshold 13. Furthermore, in various implementations, the distal edge 78 of the water barrier first leg 62 can be inserted into a groove 82 formed on the backside of the threshold nose 38, thereby connecting the water barrier 18 to the bottom of the threshold 13. Once the water barrier 18 is connected to the bottom of the threshold, e.g., to the nose 38, the door threshold system 10, e.g., the threshold 13 and connected water barrier 18, can be placed between the bottom ends of the door jams 70 on top of the respective flooring 46 such that the water barrier second leg 66 abuts the exterior side, or the face, of the boxing 52, or the band board 50 if there is no boxing 52. Hence, the door threshold system 10 is positioned between the door jams 70 such that the water barrier 18 completely covers the joint, or gap, 12 formed between the bottom of the threshold 13 and the floor structure 14.

Alternatively, in the embodiments wherein the water barrier is integrally formed with the threshold 13, initially, the door threshold system 10, i.e., the threshold 13 and integrally formed water barrier 18, can be placed between the bottom ends of the door jams 70 on top of the respective flooring 46 such that the water barrier second leg 66 abuts the exterior side, or the face, of the boxing 52, or the band board 50 if there is no boxing 52. Hence, the door threshold system 10 is positioned between the door jams 70 such that the water barrier 18 completely covers the joint, or gap, 12 formed between the bottom of the threshold 13 and the floor structure 14.

Once the door threshold system 10 is placed between the bottom ends of the door jams 70 on top of the respective flooring 46, the threshold 13 can be mounted to the top of the floor structure 14 using any suitable fasteners, as described above. In various embodiments, the water barrier 18 can subsequently be mounted to the band board 50 using any suitable fasteners, as described above. Alternatively, the door threshold system 10 can be installed by placing the door threshold system between the bottom ends of the door jams 70 on top of the respective flooring 46, then mounting the water barrier 18 to the band board 50 prior to mounting the threshold 13 to the floor structure 14. In other embodiments, wherein the water barrier 18 is integrally formed with the threshold 13, the door threshold system 10 can be installed by placing the door threshold system 10 between the bottom ends of the door jams 70 on top of the respective flooring 46, and only mounting the threshold 13 to the top of the floor structure 14 such that the water barrier second leg 66 abuts the exterior side, or the face, of the boxing 52, or the band board 50 if there is no boxing 52, but is not fastened thereto.

As described above, once the door threshold system 10 is installed, the water barrier 18 completely covers the joint, or gap, 12 formed between the bottom of the threshold 13 and the floor structure 14. Hence, the water barrier 18 prevents water, or other liquids, from penetrating, or flowing into, the joint 12 and flowing onto the flooring 46 into the interior space of the building in which the doorway 11 is constructed. Additionally, water barrier 18 prevents water, other liquids, from penetrating, or flowing into, a seam 86 formed between boxing 52 and/or the band board 50 and the flooring 46, and flowing under the flooring 46 into the interior space of the building in which the doorway 11 is constructed.

Additionally, it should be noted that the water barrier 18 is further structured to provide lateral support to the toe portion 34 of the threshold 13. That is, connecting, or integrally forming, the water barrier 18 to, or with, the threshold 13, as described above, provides lateral support to the toe portion 34 of the threshold 13. More particularly, the water barrier 18 is structured such that connecting the first leg 62 to the water barrier 18, or integrally forming the first leg 62 with the water barrier 18, as described above, will reinforce the structural integrity and rigidity of the threshold toe portion 34 such that downward forces applied to the toe portion 34 in the F direction (shown in FIG. 1B) will be considerably less likely to deform or bend the threshold toe portion 34 downward in the F direction.

Referring now to FIGS. 1 and 2, in various embodiments, the water barrier 18 is structured to have a length L that is greater than a length M of the threshold 13 such that opposing end portions 90 of the water barrier 18 extend past opposing ends 94 of the threshold toe portion 34. Therefore, in such embodiments, once the door threshold system 10 is installed, as described above, the water barrier end portions 90 will extend under opposing side trim mold pieces 98 of the door frame. Additionally, the water barrier end portions 90 can be fastened, via screws or other suitable fasteners, to the bottom of each door frame side trim mold piece 98. In such embodiments, having the water barrier end portions 90 extend beyond the ends 94 of the threshold provides additional protection from water penetrating the joint 12 and/or the seam 86.

Referring now to FIG. 3, in various embodiments, the door threshold system 10 can be included as part of a pre-hung door system 102. More particularly, the pre-hung door system 102 comprises a pre-assembled unit including the door frame, i.e., the door jams 70 and header 74, having the door 42 pre-hung on the door frame and the door threshold system 10 connected to lower or distal ends 106 of the door jams 70. In such embodiments, the door threshold system 10 is installed concurrently with the door 42 and door frame, i.e., the door jams 70 and header 74. Thus, as the pre-hung door system 102 is positioned for installation within the doorway 11, the water barrier second leg 66 is positioned to abut the exterior side, or the face, of the boxing 52, or the band board 50 if there is no boxing 52. Thereafter, the threshold 13 can be mounted to the top of the floor structure 14 using any suitable fasteners, and the water barrier 18 can be mounted to the band board 50 using any suitable fasteners, as described above. The threshold 13 and water barrier 18 can be mounted to the floor structure 14 and the band board 50, respectively, before or after that door frame, i.e., the door jams 70 and header 74, is mounted within the doorway 11.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A door threshold system comprising:
a door threshold; and
a water barrier structured to be disposed along a bottom of the threshold and to prevent water from penetrating a joint formed between a bottom of the threshold and a floor structure to which the threshold is mounted.

2. The system of claim 1, wherein the water barrier is further structured to provide lateral support to a toe portion of the threshold.

3. The system of claim 1, wherein the water barrier comprises an elongated structure that is structured to be disposed along the bottom of a toe portion of the threshold such that the water barrier covers the joint formed between the bottom of the threshold and the floor structure, thereby preventing water from penetrating the joint.

4. The system of claim 3, wherein the elongated structure has a length that is greater than a length of the threshold such that opposing end portions of the elongated structure extend past opposing ends of the threshold toe portion.

5. The system of claim 3, wherein the elongated structure comprises:
a first leg extending the length of the elongated structure and structured to be connected to the threshold toe portion; and
a second leg extending from the first leg at approximately a 90° angle and extending the length of the elongated structure.

6. The system of claim 5, wherein the second leg is structured to be connected to a band board of the floor structure such that the water barrier covers the joint formed between the bottom of the threshold and the floor structure, thereby preventing water from penetrating the joint.

7. The system of 6, wherein the first leg is structured to be connected to a nose of the toe portion to provide the lateral support to a toe portion of the threshold.

8. The system of claim 1, wherein the water barrier is integrally formed with the threshold along the bottom of a toe portion of the threshold.

9. The system of claim 1, wherein the water barrier is structured to be fastened to the toe portion of the threshold.

10. A door threshold system comprising:
a door threshold structured to be mounted to a floor structure within a door opening of a wall; and
a water barrier comprising an elongated structure that is structured to be disposed on a bottom of the threshold along a toe portion of the threshold such that the water barrier covers a joint formed between the bottom of the threshold and the floor structure when the threshold is mounted to the floor structure, thereby preventing water from penetrating the joint, the water barrier further structured to provide lateral support to the toe portion of the threshold.

11. The system of claim 10, wherein the water barrier has a length that is greater than a length of the threshold such that opposing end portions of the water barrier extend past opposing ends of the threshold toe portion.

12. The system of claim 10, wherein the water barrier comprises:
a first leg extending the length of the water barrier and structured to be connected to the threshold toe portion; and
a second leg extending from the first leg at approximately a 90° angle and extending the length of the water barrier.

13. The system of claim 12, wherein the second leg is structured to be connected to a band board of the floor structure such that the water barrier covers the joint formed between the bottom of the threshold and the floor structure, thereby preventing water from penetrating the joint.

14. The system of 13, wherein the first leg is structured to be connected to a nose of the toe portion to provide the lateral support to the toe portion of the threshold.

15. The system of claim 10, wherein the water barrier is integrally formed with the threshold along the bottom of the toe portion of the threshold.

16. The system of claim 10, wherein the water barrier is structured to be fastened to the toe portion of the threshold.

17. A pre-hung door system comprising:
a door frame comprising a header and a pair of opposing jams;
a door pivotally connected to one of the jams;
a door threshold connected at opposing ends to a bottom end of each of the opposing jams, the threshold structured to be mounted to a floor structure within a door opening of a wall in which the door system is structured to be disposed; and
a water barrier comprising an elongated structure that is structured to be disposed on a bottom of the threshold along a toe portion of the threshold such that the water barrier covers a joint formed between the bottom of the threshold and the floor structure when the threshold is mounted to the floor structure, thereby preventing water from penetrating the joint, the water barrier further structured to provide lateral support to the toe portion of the threshold.

18. The system of claim 17, wherein the water barrier has a length that is greater than a length of the threshold such that opposing end portions of the water barrier extend past opposing ends of the threshold toe portion.

19. The system of claim 17, wherein the water barrier comprises:
a first leg extending the length of the water barrier and structured to be connected to the threshold toe portion, the first leg further structured to be connected to a nose of the toe portion to provide the lateral support to the toe portion of the threshold; and
a second leg extending from the first leg at approximately a 90° angle and extending the length of the water barrier, the second leg structured to be connected to a band board of the floor structure such that the water barrier covers the joint formed between the bottom of the threshold and the floor structure, thereby preventing water from penetrating the joint.

20. The system of claim 17, wherein the water barrier is integrally formed with the threshold along the bottom of the toe portion of the threshold.
